(19) United States
(12) Patent Application Publication
(10) Pub. No.: US 2013/0325216 A1
(43) Pub. Date: Dec. 5, 2013

(54) SYSTEM AND METHOD FOR AUTHORIZING STOPPAGE OF PILOTING TASKS

(71) Applicant: THALES, Neuilly-sur-Seine (FR)

(72) Inventors: Camille RIEUNIER, Valence (FR); Jerome SACLE, Toulouse (FR); Gabrielle DE BRITO, Lapeyrousse-Fossat (FR); Sylvain HOURLIER, Bordeaux (FR)

(21) Appl. No.: 13/907,298

(22) Filed: May 31, 2013

(30) Foreign Application Priority Data
Jun. 1, 2012 (FR) 12 01574

(51) Int. Cl. B64C 19/00

(52) U.S. Cl. CPC B64C 19/00
USPC 701/3

(57) ABSTRACT

A system and method for authorizing stoppage of piloting tasks performed by at least one pilot of an aircraft equipped with automatic piloting means is disclosed. A duration for which the stoppage is authorized is determined, the duration being determined based on the calculation of an instant of commencement of a next action, and the next action being an action not yet carried out that must be carried out first by the pilot. The duration is then displayed.

### CROSS-REFERENCE TO RELATED APPLICATION

This application claims priority to foreign French patent application No. FR 12 01574, filed on Jun. 1, 2012, the disclosure of which is incorporated by reference in its entirety.

### FIELD OF THE INVENTION

The invention lies in the field of systems for aiding flight management.

### BACKGROUND

These systems comprise in particular the system known by the English name of “Flight Management System” or “FMS”, meteorological radar or “Weather radar” and traffic alert and collision avoidance system, also known by the English acronym of “TCAS” signifying “Traffic alert and Collision Avoidance System”.

During a flight, a member of the technical crew of an aeroplane may need to absent himself from the cockpit in order to take a rest, for a physiological need or to solve a problem arising in the cabin. Likewise, the operators of drones when they are simultaneously controlling several drones may be led to delegate (to an automatic piloting system for example) the control of one or more drones so as to concentrate on the control of other drones, the latter drones performing for example critical actions. In this invention, the system is usable by a member of the technical crew of an aeroplane or an operator of a drone. Hereinafter in this document, the expression “pilot” is used to designate either a member of the technical crew of an aeroplane or an operator of a drone. Likewise, the expression “aircraft” is used to designate either an aeroplane, a drone or any other flying machine controlled by a man. Likewise the expression “stop the tasks for piloting an aircraft” can designate the exiting of the cockpit by the pilot or the shelving of the piloting tasks.

Currently, when a pilot wishes to stop the piloting of an aircraft, he must analyze the information at his disposal to determine whether a stoppage of the piloting tasks is authorized. Stoppage of the piloting tasks is considered to be authorized if this stoppage is conceivable, relevant and does not jeopardize the safety of the aircraft. He must also determine the duration for which this stoppage of the piloting tasks can be carried out without danger. This determination must be carried out so as to avoid inappropriate stoppages, for example stoppages taking place at the moment at which the probability of occurrence of an event is high and at which management with a single pilot is complex. Indeed, an inappropriate absence may impact flight safety. This determination requires a good summary knowledge of the current situation of the flight on the part of the pilot or pilots, a capacity for objective analysis and anticipation of the events of the flight that could happen in the near future.

In the prior art there does not exist any system making it possible to aid the pilot or pilots in the decision-making regarding stoppage of the piloting tasks and in the determination of the duration of this stoppage.

### SUMMARY OF THE INVENTION

The object of the present invention is therefore a system making it possible to indicate to the pilot of an aircraft whether he is authorized to stop the aircraft piloting tasks.

There is proposed, according to one aspect of the invention, a system for authorizing stoppage of the piloting tasks performed by at least one pilot of an aircraft equipped with automatic piloting means. The system comprises means for determining a duration for which the stoppage is authorized. This duration is determined on the basis of the calculation of an instant of commencement of a next action, this next action being the action not yet carried out that must be carried out first by the pilot. The system also comprises means for displaying the duration.

This system therefore aids the pilot or pilots in the determination of the authorization of a stoppage of the piloting tasks and in the determination of the duration of this stoppage.

Advantageously the determining means are adapted for determining the duration on the basis;

of values of parameters representative of the physical state of the pilot or pilots and/or;

of values of parameters representative of the meteorological conditions over the flight path of the aircraft and/or;

of values of parameters representative of the air traffic over the flight path of the aircraft and/or;

of values of parameters representative of the operating state of the aircraft and/or;

of values of parameters representative of the position and the flight path of the aircraft.

Advantageously the determining means comprise;

sub-means for comparing the values of the parameters with reference values and

sub-means for summarizing the results of the said comparisons.

Advantageously the determining means are adapted for determining the duration on the basis furthermore of messages exchanged between the aircraft and the entities in charge of air traffic control.

Advantageously the display means are adapted for being fixed to the aircraft's control means and/or to be transported by the pilot.

Advantageously the determining means are adapted for furthermore determining a probability of reliability of the duration on the basis of the calculation of the instant of commencement of the next action and the display means are adapted for furthermore displaying the said probability of reliability.

Advantageously the determining means are adapted for performing this determination periodically and the display means are adapted for updating the display periodically.

According to a technical characteristic the aircraft is an aeroplane, a drone or a helicopter.

According to a technical characteristic the automatic pilot is active and can control the aircraft.

The invention also relates to a method for authorizing stoppage of the piloting tasks performed by at least one pilot of an aircraft equipped with automatic piloting means. The method comprises;

a step of determining a duration for which the stoppage is authorized, the duration being determined on the basis of the calculation of an instant of commencement of a next action, not yet carried out, that must be carried out first by the pilot and;

a step of displaying the duration.

### BRIEF DESCRIPTION OF THE DRAWINGS

The invention will be better understood and other advantages will become apparent on reading the detailed description, given by way of nonlimiting example. This detailed description is carried out with the aid of the following figures:

FIG. 1 presents the system for authorizing stoppage of piloting tasks, according to one aspect of the invention.

FIG. 2 presents the determining device, according to one aspect of the invention.

FIG. 3 presents the method for authorizing stoppage of piloting tasks, according to one aspect of the invention.

### DETAILED DESCRIPTION

The system makes it possible to indicate to the pilot whether he is authorized to stop the piloting operations. It also indicates the authorized duration of this stoppage and the reliability percentage. This system is not intended to replace the pilot's final decision, but it makes it possible to strengthen his decision-making, and optionally to signal to him that an absence at this moment of the flight is not judicious, for example because the pilot has not been apprised of a future significant event.

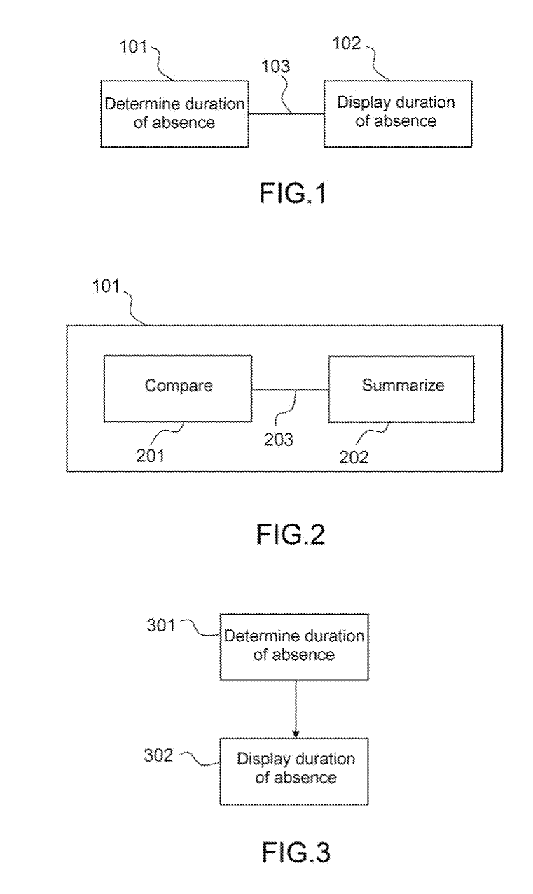

FIG. 1 represents the system described in the invention. The system comprises a device 101 for determining a duration for which a pilot is authorized to suspend his performance of the piloting tasks. This determination is carried out by calculating the instant of commencement of the next action that must be carried out by the pilot. In order to calculate this instant of commencement correctly, it is necessary to take into account the time for reflection that must be undertaken by the pilot before carrying out this action. The system also comprises a device 102 for displaying the duration of authorization of suspension of the performance of the piloting tasks on the basis of the result 103 of device 101 for determining a duration. In an improvement of this system, the determining device 101 is also adapted for determining the probability of reliability of the said duration and the display device 102 is adapted for displaying this probability. Another improvement of this system allows the determining device 101 and the display device 102 to perform their determination and their display periodically. A new determination and a new display can be carried out upon the detection of a new event in the environment of the aircraft or upon the updating of the values of the parameters monitored by the aircraft control systems. The new determination and the new display can also be carried out upon a change in the flight phase or upon reception of a communication with the authorities in charge of air traffic control (also known by the English name “ATC” for “Air Traffic Control”). Finally the new determination and the new display can also be carried out at regular intervals, for example every two minutes.

The display device 102 makes it possible to display the information obtained from the determining device 101. This information comprises: the stoppage authorization, the duration of this authorization and the probability of reliability of this duration of authorization. This information may be available in a permanent manner, with periodic updating or on the request of the pilot. In the case where the stoppage is not authorized, it is possible for this device to display the parameters which do not comply with the stoppage criterion and the mismatch between the value of these parameters and the reference value authorizing stoppage. This advantageously allows the pilot to verify that the situation such as he is apprised thereof and such as described by the system are mutually consistent. The display device 102 can be fixed on the control desk or can be transportable by the pilot. In the case where the display device 102 is transportable, a wireless data link ensures the transmission of the information between the determining device 101 and the display device 102.

The determining device 101 is adapted for using the value of various parameters, in particular:

parameters describing the physical state of the pilot or pilots;

parameters describing the meteorological conditions over the flight path of the aircraft;

parameters describing the air traffic over the flight path of the aircraft;

parameters describing the operating state of the aircraft;

parameters describing the position and the flight path of the aircraft.

Moreover the determining device 101 is adapted for using the messages exchanged between the aircraft and the entities in charge of air traffic control. These messages are also known by the name of ATC messages (“ATC” signifying “Air Traffic Control”). These messages comply with the standard RTCA DO 219/ED110. They make it possible in particular for the pilot of the aircraft to be given instructions; these instructions having to be carried out immediately, after a time delay or else after a determined event.

FIG. 2 represents a variant of the determining device 101. The latter comprises a comparison unit 201. This unit 201 compares the value of the various parameters with a reference for which the stoppage of the piloting tasks is authorized. This comparison can be strict or graduated. In the case of a strict comparison, the result is positive or negative depending on whether the value of the parameter is below or above the reference. In the case where the comparison does not make it possible to obtain a result of above or below type (for example when the comparison pertains to a flight phase), it is possible to obtain a result of the type: equality or difference between the value of the parameter and the reference. It is also possible to obtain a result of the type: membership or otherwise of the value of the parameter in a particular domain. Among these strict comparisons some are graded as necessary if it is obligatory that they be positive or successful in order to authorize stoppage of the piloting tasks.

In the case where the comparison is graduated, the result is a percentage which depends on the ratio of the value of the parameter to the reference value (for example, for the “flight level” aircraft parameter, if the aeroplane is flying at the level FL280—“FL” being an English acronym for “Flight Level”—whereas the reference indicates a minimum level FL300, the result of the graduated comparison is then 280/300=93%). The choice of a strict or graduated comparison depends on the parameter considered.

The determining device 101 also comprises a unit 202 for summarizing the results of the comparisons 203 obtained from the comparison unit 201. This unit therefore summarizes the results of the various comparisons obtained from the comparison unit 201. This summary is achievable in three different ways:

1) So-called “strict” summary, in which all the strict comparisons must be positive or successful in order to authorize stoppage of the piloting tasks;

2) So-called “strict by levels” summary, in which a determined number of strict comparisons must be positive or successful in order to authorize stoppage of the piloting tasks;

3) So-called “graduated” summary in which the sum of the results of the graduated comparisons must exceed a threshold in order to authorize stoppage of the piloting tasks.

Stoppage of the piloting tasks may be considered to be authorized in the case where the following three conditions are complied with; 1) all the necessary strict comparisons are positive or successful 2) more than 70% of the strict comparisons are positive or successful 3) the average of the reliability of the various graduated comparisons lies between 70 and 100%.

This summarizing unit 202 also makes it possible to calculate the probability of reliability of the authorization. This calculation of the probability of reliability depends on the type of summary carried out. In the case of a so-called “strict” summary, the probability of reliability is then binary, it equals one if stoppage authorization is granted and it equals zero if stoppage authorization is denied. In the case of a so-called “strict by levels” summary, the probability of reliability is then the ratio of the number of strict comparison which have been positive, to the total number of comparisons. In the case of a so-called “graduated” summary, the probability of reliability can be the ratio of the sum of the results of the comparisons to the number of comparison, multiplied by 100, if the results of the comparisons are expressed as a percentage with respect to the reference serving for authorization.

This summarizing unit 202 also makes it possible to calculate the authorized duration of stoppage of the piloting tasks. This duration is defined as a function of the value of the various parameters and of the role of these parameters. For example, the determination of this duration takes into account the flight phase duration remaining before the pilot must take a piloting action or must make contact with the ground entity in charge of air traffic. The determination of this duration can also take into account the number of pilots and the physical state of the remaining pilot. The meteorological and traffic conditions are also taken into consideration to determine the authorized duration of stoppage.

In a first mode it may be considered that the authorized duration of stoppage of the piloting tasks is the most restrictive duration of the set of durations obtained through the comparisons between the value of a parameter and the reference value. Thus the authorized duration of stoppage of the piloting tasks is the minimum duration obtained from the various comparisons.

In a second mode, it may be considered that the authorized duration of stoppage of the piloting tasks is an average of the authorized durations of stoppage of the piloting tasks obtained during the various comparisons. The choice of one or the other mode is performed, in particular, as a function of the fact that a second pilot remains in post, during the stoppage of the piloting tasks by the first pilot. In post signifies that the pilot is sitting in his seat and is able to ensure the piloting tasks.

In a third mode, the authorized duration of stoppage is the minimum among the following durations:

the minimum duration for which the necessary strict comparisons remain positive or successful

the minimum duration for which more than 70% of the strict comparisons remain positive or successful

the minimum duration for which the average of the reliability of the various graduated comparisons remains between 70 and 100%.

The instant of commencement of the authorized stoppage of the piloting tasks can be considered to be the immediate instant. In this situation the pilot can therefore stop the piloting tasks immediately.

The authorized duration of stoppage of the piloting tasks can be updated on the expiry of the authorization timescale or upon an event that modifies the calculation of this duration. In order to allow the pilot to obtain in real time the modification of the duration, the display device 102, in addition to being able to be fixed on the control devices (cockpit of an aeroplane or control desk of a drone) can also be transported by the pilot.

The various parameters describing the physical state of the pilot or pilots and the optional reference values are as follows:

the number of pilots already present at their post (1, 2 or 3, depending on the configuration of the aircraft);

the state of health of the pilot or pilots remaining in the cockpit in particular heartbeat, activity, blinking of the eyes, electrocardiogram, etc.;

the state of fatigue of the pilot or pilots remaining in the cockpit in particular blinking of the eyes, reaction time, ocular fixation, mismatch in the performance of actions, etc.

The various parameters describing the meteorological conditions and the optional reference values are as follows:

the position, the number and the type of the cumulonimbus present over the flight path of the aeroplane. The pilot is authorized to stop the piloting tasks if these cumulonimbus are at a distance of more than 100 to 250 nautical miles (the nautical mile is a unit for measuring distance equal to 1852 meters) and if they are not attained in under 15 to 30 minutes;

the position of zones comprising turbulence or exhibiting a risk of icing. The pilot is authorized to stop the piloting tasks if these zones are not attained in under 15 to 30 minutes.

The values of the various weather-related parameters can be obtained by the aircraft's weather radar or by the ground entity in charge of air traffic. The reliability of the various values of the parameters is also taken into account in order to base the determination of the authorized duration of stoppage of the piloting tasks on reliable parameters alone.

The various parameters describing the traffic conditions and the optional reference values are as follows:

The position and the zone of crossing of aircraft travelling along a flight path crossing the flight path of the aircraft;

and the difference in altitude at the moment of crossing with the other aircraft.

The forecast flight path of the other aircraft is calculated using the flight plan filed by these aircraft.

The pilot is authorized to stop the piloting tasks if the difference in altitude between his aircraft and the various other aircraft at the moment of crossing is greater than a value lying between 1000 and 4000 feet (the foot is a unit for measuring distance equal to 304.8 mm).

The value of these parameters is determined by the traffic alert and collision avoidance system, also known by the English acronym of “TCAS” signifying “Traffic alert and Collision Avoidance System”. It is also possible to use a second system for detecting traffic in order to take account of aircraft situated a greater distance away than those observable by the “TCAS” system. The reliability of the various values of the parameters is also taken into account in order to base the determination of the authorized duration of stoppage of the piloting tasks on reliable parameters alone.

The various parameters describing the aircraft's operating state are for example those describing the state of the aircraft's systems (pressurization of the cabin, state of the electrical networks, state of the hydraulic networks, reserve of fuel, oxygen, operating state of the engines) and those describing the state of the avionics (in particular the presence of faults at the level of the communication systems, at the level of the automatic pilot, at the level of the FMS, at the level of the computing networks, etc.). The values of these various parameters are given by the alert system also known by the English name of “Flight Warning System”. The reliability of the various values of the parameters is also taken into account in order to base the determination of the authorized duration of stoppage of the piloting tasks on reliable parameters alone.

The various parameters describing the position and the flight path of the aircraft are in particular those:

Making it possible to indicate the distance to destination. The pilot can be authorized to stop the piloting tasks if the destination is a greater distance away than a value lying between 50 to 200 nautical miles.

Making it possible to indicate the current altitude of the aircraft. The pilot can be authorized to stop the piloting tasks if the current altitude is greater than a value lying between the flight level FL150 and the flight level FL280.

Making it possible to indicate the obstacle-free distance ahead of the flight path of the aeroplane or under the aeroplane. This parameter is also known by the English name of “MORA” for “Minimum Off Route Altitudes”. The pilot can be authorized to stop the piloting tasks if there is no obstacle at a distance of less than 10 000 feet. It is possible for this parameter to use a graduated comparison. In this case, a mismatch of 1000 feet with the reference value causes a degradation of a certain determined percentage of the probability of reliability of authorization. This percentage can have a value of between 1% and 10%.

Making it possible to indicate the altitude of the aircraft with respect to the parameter known by the English name of “MEA” for “Minimum en route Altitude”. The MEA is the minimum altitude that must be followed by an aircraft on a given section of air route (this section of air route is delimited by two 2 points). It can according to the definition given thereto take into account the reception of the radio navigation signals. However, since modern aircraft fly using the satellite location system known by the English name of “GPS” for “Global Positioning System” as primary means of navigation, the fact of being able to receive radio navigation signals correctly becomes secondary with respect to the safety achieved by the knowledge of other obstacles, afforded by the MEA. The value of the MEA depends on the place considered and the variations of the value of the MEA as a function of location are included in the navigation database. The pilot can be authorized to stop the piloting tasks if this parameter is greater than a value lying between 3000 and 8000 feet.

Making it possible to indicate the future change of flight information region (also known by the English acronym “FIR” for “Flight Information Region”). The pilot can be authorized to stop the piloting tasks if the change of flight information region takes place beyond 10 to 20 minutes. This parameter is used in the case of a configuration of the aircraft with only one pilot. In the case of two pilots this parameter is not taken into account in determining whether the stoppage of the piloting tasks is authorized.

Making it possible to indicate arrival at a military, dangerous or prohibited zone. The determining device 101 uses the information of the FMS to determine the time required for arrival at this zone. If this time is less than 10 to 20 minutes the pilot can be authorized to stop the piloting tasks. This parameter is used in the case of a configuration of the aircraft with only one pilot. In the case of two pilots this parameter is not taken into account to determine whether the stoppage of the piloting tasks is authorized. The reliability of the various values of the parameters is also taken into account in order to base the determination of the authorized duration of stoppage of the piloting tasks on reliable parameters alone.

The various messages exchanged between the aircraft and the entities in charge of air traffic control are interpreted by the determining device 101 to determine whether a stoppage of the piloting tasks is authorized. This interpretation of the messages makes it possible to provide for the forthcoming actions. For example certain types of messages include a condition, on the commencement or the end of the action to be carried out, described in the message. This condition can be expressed in the form of a time (messages of type AT (time)) or in the form of a position (messages of type AT (position)). In the case where the condition is expressed in the form of a time, the determining device 101 effects a difference between the time at which the action must be carried out and the current time. In the case where the condition is expressed in the form of a position, the determining device 101 uses the FMS in order to determine the time required to reach the position. This required time is then used to determine the duration of authorization of stoppage of the piloting tasks.

The following paragraph describes by way of nonlimiting example a situation in which an authorization to stop the piloting tasks is determined by the system described in the invention. The various values of the parameters serving to determine the duration and the reliability of the authorization to stop the piloting tasks are as follows:

The flight level is equal to or greater than the level FL300.

The parameters describing the operating state of the aircraft's systems indicate that there is no unresolved system fault of “WARNING” criticality level. Moreover, if they indicate that there are faults of “CAUTION” criticality level, these faults relate to the secondary functions and systems (The values of these parameters are transmitted by the Flight Warning System).

The weather radar indicates that there are no meteorological alerts (storms, risks of turbulence or of icing) at a distance of 80 nautical miles or 10 minutes ahead of the flight plan envisaged by the aircraft.

The TCAS system indicates that there is no air traffic converging in a zone of 2000 feet around the aircraft.

Two pilots are present in the cockpit and the remaining pilot is in a good physical state

There is no response to an ATC message or any actions to be performed subsequent to an ATC command in the next 10 minutes.

In this situation the determining device 101 determines that the authorized duration of stoppage of the piloting tasks is 10 minutes. This authorized duration is then displayed on the display device 102.

FIG. 3 presents a method for authorizing stoppage of the piloting tasks performed by at least one pilot of an aircraft equipped with automatic piloting means. The method comprises the following steps;

a step 301 of determining a duration for which the stoppage is authorized, the duration being determined on the basis of the calculation of an instant of commencement of a next action, not yet carried out, that must be carried out first by the pilot and;

a step 302 of displaying the duration.

1. A system for authorizing stoppage of piloting tasks performed by at least one pilot of an aircraft equipped with automatic piloting means, the system comprising:
means for determining a duration for which the stoppage is authorized, the duration being determined based on calculation of an instant of commencement of a next action, not yet carried out, that must be carried out first by the at least one pilot; and
means for displaying the duration.

2. The system of claim 1, wherein the determining means are configured to determine the duration based on:
values of parameters representative of a physical state of the at least one pilot,
values of parameters representative of a meteorological condition over a flight path of the aircraft,
values of parameters representative of air traffic over the flight path of the aircraft,
values of parameters representative of an operating state of the aircraft, or
values of parameters representative of a position of the aircraft and the flight path of the aircraft.

3. The system of claim 2, wherein the determining means comprise:
means for comparing the values of the parameters with reference values; and
means for summarizing results of the comparisons.

4. The system of claim 1, wherein the determining means are further configured to determine the duration based on messages exchanged between the aircraft and entities in charge of air traffic control.

5. The system of claim 1, wherein the display means are configured to be fixed to a control means of the aircraft or to be transported by the pilot.

6. The system of claim 1, wherein the determining means are further configured to determine a probability of reliability of the duration based on the calculation of the instant of commencement of the next action, and wherein the display means are further configured to display the probability of reliability.

7. The system of claim 1, wherein the determining means are further configured to periodically determine the duration, and wherein the display means are further configured to periodically update display of the duration.

8. The system of claim 1, wherein the aircraft is an aeroplane, a drone or a helicopter.

9. The system of claim 1, wherein the automatic piloting means are active and are configured to control the aircraft.

10. A method for authorizing stoppage of piloting tasks performed by at least one pilot of an aircraft equipped with automatic piloting means, the method comprising:
determining a duration for which the stoppage is authorized, the duration being determined based on calculation of an instant of commencement of a next action, not yet carried out, that must be carried out first by the at least one pilot; and
displaying the duration.
